(19) United States
(12) Patent Application Publication
(10) Pub. No.: US 2010/0159991 A1
(43) Pub. Date: Jun. 24, 2010

(54) Reliable femtocell system for wireless communication networks

(75) Inventors: I-Kang Fu, Taipei City (TW); Chao-Chin Chou, Taipei City (TW); Yih-Shen Chen, Hsinchu City (TW)

Correspondence Address: IMPERIUM PATENT WORKS, P.O. BOX 607, Pleasanton, CA, 94566, US

(73) Assignee: MediaTek Inc.

(21) Appl. No.: 12/655,042

(22) Filed: Dec. 21, 2009

Related U.S. Application Data
(60) Provisional application No. 61/139,656, filed on Dec. 22, 2008.

(51) Int. Cl. H04W 4/12

(52) U.S. Cl. 455/561; 455/466

(57) ABSTRACT

A Femto Base Station (FBS) includes a communication functionality and a reliability functionality. A control entity within the reliability functionality detects an FBS reliability compromising event (for example, an unscheduled loss of external power to the FBS). As a result of detecting the FBS reliability compromising event, the control entity sends a message (an “FBS Reliability Compromising Event Compensation Message” or “FBSRCECM”) to the communication functionality. The FBSRCECM initiates an action that compensates for the FBS reliability compromising event. In many examples, the action is the initiating of a handover from the FBS to another base station. The reliability functionality typically includes a rechargeable battery that powers the FBS for a time until the handover is completed gracefully. By performing a graceful handover, cellular network reliability is improved as compared to situations in which a conventional FBS simply stops working and connections handled by the conventional FBS are broken.

### CROSS REFERENCE TO RELATED APPLICATION

This application claims priority under 35 U.S.C. §119 from U.S. Provisional Application No. 61/139,656, entitled “Reliable Femtocell System for Wireless Communication Networks,” filed on Dec. 22, 2009, the subject matter of which is incorporated herein by reference.

### TECHNICAL FIELD

The present invention relates Femto Base Stations (FBSs), and more particularly to FBSs that communicate using a WiMAX, IEEE 802.16, 3GPP UMTS or 3GPP LTE communication protocol.

### BACKGROUND

FIG. 1 (Prior Art) is a diagram that shows a part of a cellular network 1 sometimes referred to as a cell 2. Cell 2 is the coverage area of a Macro Base Station (MBS) 3. There are many such MBSs that make up the overall cellular network. A Mobile Station (MS) can move from one cell to another. As a MS passes out of one cell and into another cell, the wireless communication link between the MS and the cellular network is handed off from one MBS of one cell, to the next MBS of the next cell. In the diagram of FIG. 1, the block 4 labeled “cellular network” represents a networked set of such BS. Cellular network 4 is connected to the internet 5 via a broadband link or links 6. The user of an MS can use the MS to access the internet via the cellular network. In the illustrated example, an MS 7 is located out of doors. The Radio Frequency (RF) cellular communication signal link 8 between MBS 3 and MS 7 is relatively strong and the link is a relatively high bandwidth link. The link provides a relatively high Quality of Service (QoS). MS 7 is usable to consume services that require relatively high bandwidth communication between the MS and the internet.

In the illustrated example of FIG. 1, however, another MS 9 is located inside a building 10. Due to the building, the RF cellular communication link 11 between MS 9 and MBS 3 is weak. This link does not provide a high QoS. The weak link makes accessing services that require high bandwidth communication between the mobile station and the internet unpleasant and slow. In such situations, users often decline to use the cellular network to access internet services and often opt to use a separate access point 12 to access the internet. In a typical example, access point 12 is a WiFi access point that communicates in accordance with mobile stations using an IEEE 802.11 standard. The link between access point 12 and MS 9 is a strong high-bandwidth link 13 offering good QoS. Access point 12 is also connected to the Internet via a wired broadband link 14 referred to as the backhaul link. Backhaul link 14 is provided by an Internet Service Provider (ISP) that is a different entity than the entity operating the cellular network. As a result, the cellar network operator entity loses potential revenue that otherwise might be derived if the cellular operator could have provided the bandwidth-intensive internet content to the user through the cellular network.

FIG. 2 (Prior Art) illustrates a possible solution to the problem discussed above in connection with FIG. 1. In FIG. 2, a small base station 15 of limited communication range, referred to here as a “Femto Base Station” (FBS), is used to provide access to cellular network 4. FBS 15 is typically installed inside the building 10 as illustrated. An FBS typically provides very small cell coverage (e.g. <35 meters) but provides extreme high-speed transmission for indoor communication devices. The FBS uses the same air-interface cellular communication protocol and may use the same licensed spectrum as another MBS in the cellular network. By using the same air-interface cellular communication protocol in the same licensed spectrum as MBS 3, the cellular network operator can derive increased revenue from providing the user high bandwidth indoor wireless services. Unlike access point 12 of FIG. 1, FBS 15 of FIG. 2 is part of the cellular telephone network and communicates using the same cellular telecommunications protocol used by the base station and the mobile stations. Because of the proximity of FBS 15 and MS 9 inside the building, however, the reliability and bandwidth of communication link 16 between MS 9 and the cellular network is improved as compared to the example of FIG. 1. The user need not resort to using an access point that is not part of the cellular network. The FBS 15 is typically connected to the internet by a broadband “backhaul” connection 17.

If, for example, the user of MS 9 were to want to access a bandwidth-intensive internet service, then the user may elect to use MS 9 to communicate with a server on the internet via FBS 15, backhaul link 17, an ISP-provided link 18, link 19, cellular network 14, and link 6 back to the internet 5. The overall communication link therefore passes through the cellular network, and the cellular network operator may derive revenue from providing the internet-based services to the user.

Problems, however, may present themselves where FBSs are utilized, especially where numerous inexpensive FBSs are utilized in the same cellular network by nonprofessionals. Unlike the large macro base stations of the cellular network that are maintained and operated in a reliable manner by the cellular network operator, the FBSs are typically inexpensive equipment that are operated in a less reliable fashion by individual users. Such an individual user may not realize, or even care, that actions taken by the user with the user's local FBS may adversely impact operation of the remainder of the cellular network. Impacts on operation of such a cellular network may be complex and varied, depending on the particular situation and the actions of the user. Solutions to such undesirable impact on the cellular network are desired.

### SUMMARY

A Femto Base Station (FBS) includes communication functionality and novel reliability functionality. The communication functionality includes an air-interface and a backhaul modem. The air-interface may, for example, be an air-interface for communicating in accordance with a WiMAX, an IEEE 802.16, a 3GPP UMTS or a 3GPP LTE communication protocol. In one example, the communication functionality includes an air-interface integrated circuit, a network processor, and a backhaul modem.

The novel reliability functionality, in one example, includes an External Power and Power Backup Source (EPPBS) and a control entity. The EPPBS includes a rechargeable battery and a power supply/battery charger circuit. The power supply/battery charger circuit receives external AC power from external power terminals, and generates a DC supply voltage usable by the remainder of the FBS circuitry, and keeps the rechargeable battery charged under normal operating conditions. If for some reason the EPPBS will not be able to continue to supply power to the FBS, then the EPPBS outputs “power status information” to the control entity. This power status information alerts the control entity of an upcoming future interruption of operating power.

In one method, the FBS experiences and detects what is referred to here as an “FBS Reliability Compromising Event.” An example of the FBS reliability compromising event is an unscheduled unplugging of the FBS from AC wall power (110 Volts AC or 220 Volts AC) by the user. The EPPBS within the FBS detects this event and in response outputs the “power status information” to the control entity as described above. The power status information alerts the control entity of the event. In response, the control entity sends an “FBS Reliability Compromising Event Compensation Message” (FBSRCECM) to the communication functionality, thereby initiating the sending of a message from the FBS. In one example, the message sent from the FBS initiates a handover of a Mobile Station (MS) served by the FBS to a macro BS of the cellular network of which the FBS is a part. The message may be a handover request sent via the backhaul modem of the communication functionality to the macro BS via a wired network connection. Alternatively, the message is a handover command sent via the air-interface of the communication functionality to the MS. Regardless of the type of message that initiates the handover, it is assured that the FBS will be powered during the transmission of the message due to the battery within EPPBS. Typically the FBS interacts and communicates with the MS and/or cellular network to facilitate complete handover of the MS while the EPPBS is powering the FBS.

In the example above, the “FBS reliability compromising event” is an unscheduled unplugging of the FBS by the user. There are, however, other examples of FBS reliability compromising events. Other examples of FBS reliability compromising events include: a disconnection of a backhaul network connection to the FBS, an occurrence of congestion in a backhaul network connection to the FBS, an occurrence of congestion in an air-interface connection to the FBS, a receipt onto the FBS of a message to reconfigure the FBS from a backhaul controller, and a receipt onto the FBS of a message to shut down the FBS from a backhaul controller. Rather than the FBS responding to the FBS reliability compromising event by sending a message to initiate a handover of a mobile station served by the FBS, the FBS may in other examples send one of the following messages: a command sent to a mobile station to enter an idle mode, a message indicative of the FBS reliability compromising event, an error message, a message that includes a recommendation for fixing an error. The message sent out from the FBS in response to the FBS reliability compromising event need not be a message to initiate a handover in all examples. The message may, for example, be a message that causes the cellular network to reconfigure itself to increase bandwidth (throughput) of the link between the FBS and the remainder of the cellular network. The message may be an error message that indicates a potential error or problem and proposes a solution to the error of problem. The message may be sent to a mobile station, to a macro base station, or to another entity such as the backhaul controller entity. Regardless of the type of message sent out from the FBS and regardless of the recipient(s) of the message, the message serves to increase reliability of the overall cellular network of which the FBS is a part.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) is a diagram of a cellular network that includes a Macro Base Station (MBS) and two Mobile Stations (MSs). One of the MSs can also access the internet using a WiFi access point.

FIG. 2 (Prior Art) is a diagram of a cellular network that includes an MBS and two MSs. One of the MSs can access the internet using a Femto Base Station (FBS).

FIG. 3 is a diagram of a system 50 in accordance with one novel aspect. The system includes a cellular network involving a plurality of MBSs, a backhaul network, and a novel FBS.

FIG. 4 is a more detailed diagram of one example of the broadband access connection in FIG. 3 between FBS 65 and the internet 81.

FIG. 5 is a simplified block diagram of the novel FBS 65 of FIG. 3.

FIG. 6 is a flowchart of a first novel method 200.

FIG. 7 is a flowchart of a second novel method 300.

FIG. 8 is a flowchart of a third novel method 400.

FIG. 9 is a flowchart of a fourth novel method 500.

FIG. 10 is a flowchart of a fifth novel method 600.

FIG. 11 is a flowchart of a generalized novel method 700.

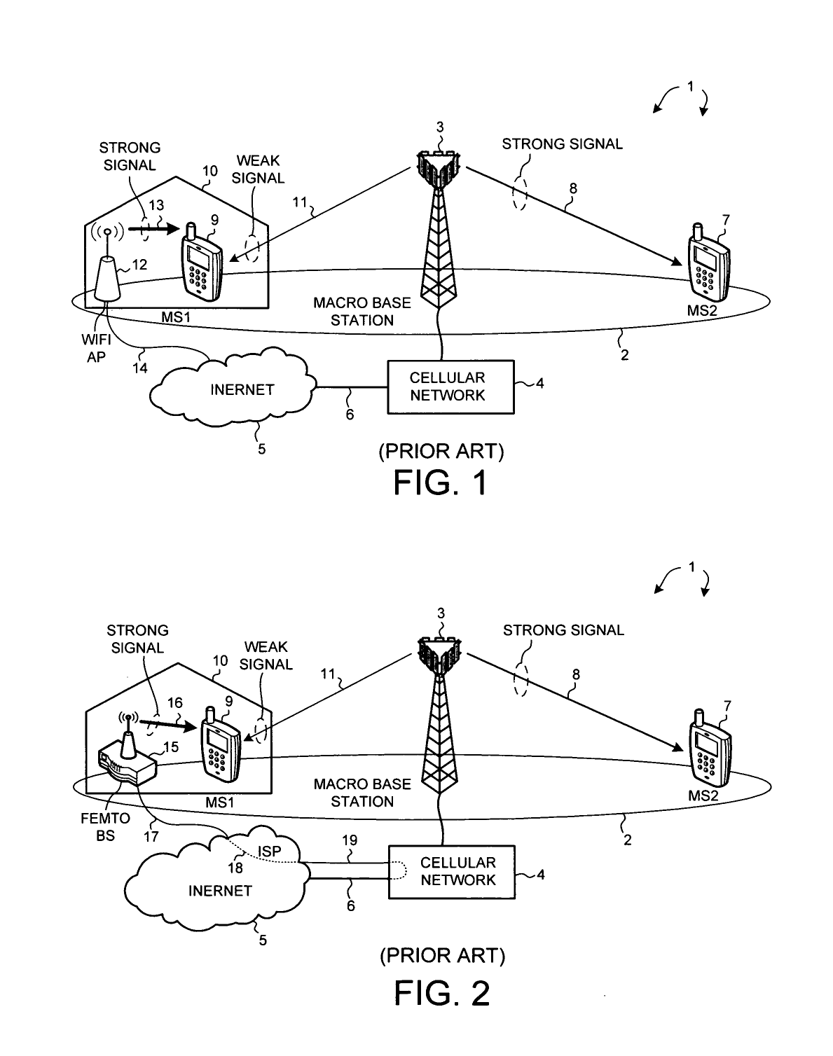

### DETAILED DESCRIPTION

Reference will now be made in detail to some embodiments of the invention, examples of which are illustrated in the accompanying drawings.

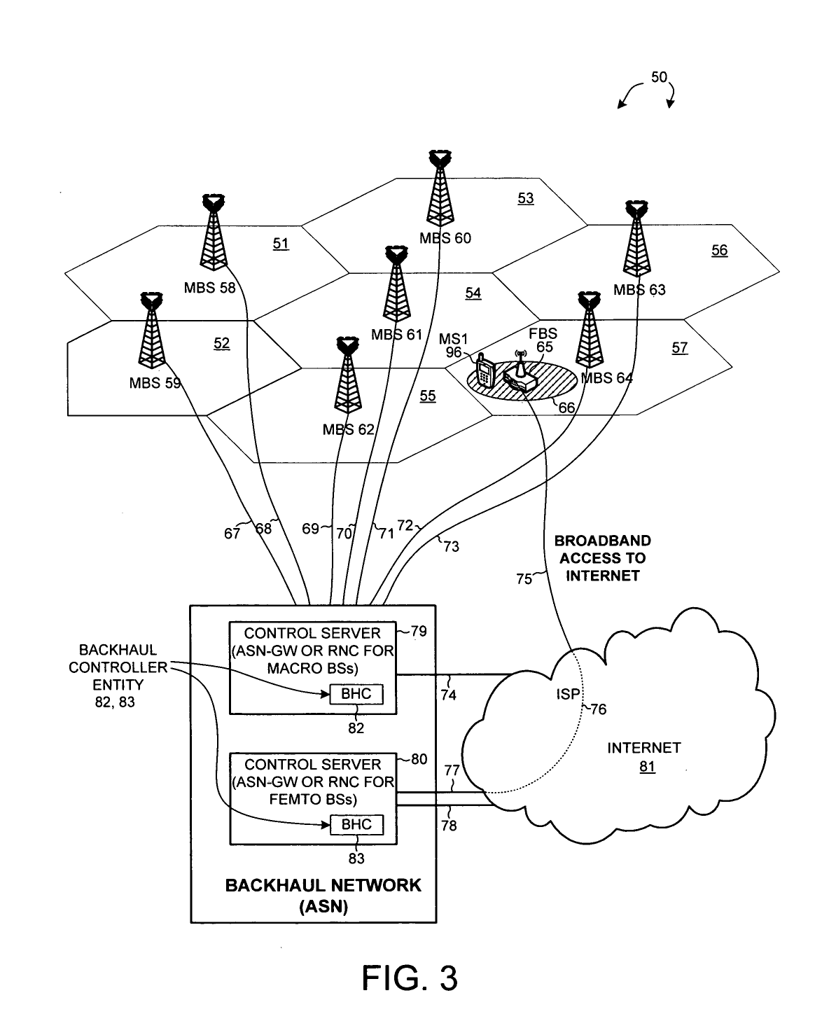

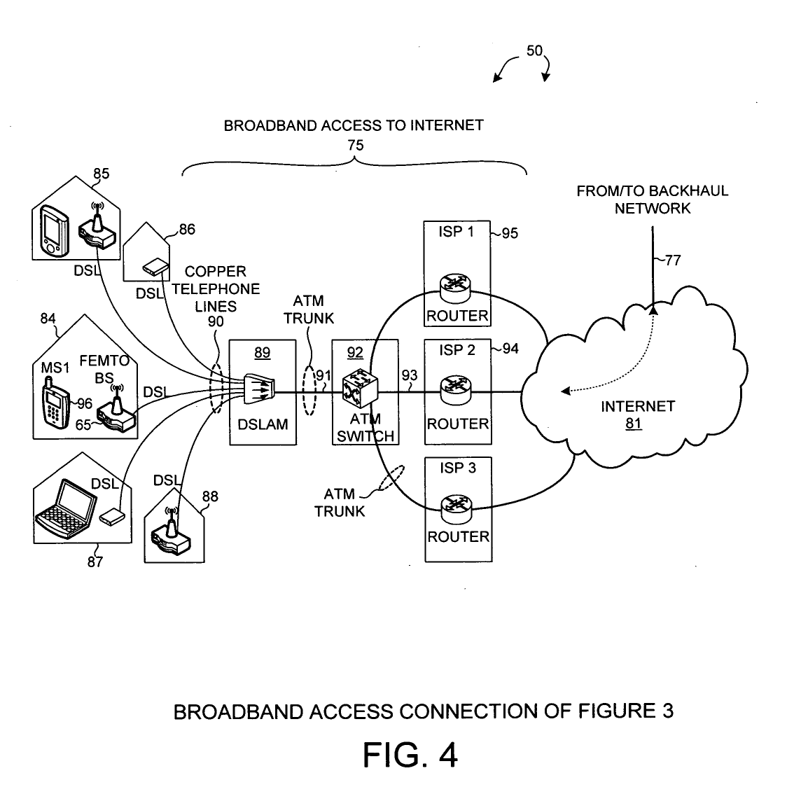

FIG. 3 is a diagram of a system 50 in accordance with one novel aspect. System 50 includes a cellular communication network involving a plurality of cells 51-57. A Macro Base Station (MBS) serves each of the cells. The MBSs illustrated are identified by reference numerals 58-64. The cellular telephone network further includes many Femto Base Stations (FBSs), one of which is illustrated as FBS 65. FBS 65 has its own smaller coverage area or cell 66. MBSs 51-57 and FBS 65 are networked together by communication links and associated network equipment. These communication links are represented by lines 67-78 and the network equipment is represented by blocks 79 and 80. The lines and blocks 67-80 are provided for illustrative purposes. The actual cellular network and backhaul structure that interconnects the MBSs and FBSs may take various other forms and may involve wireless links and other hardware and software functionality as is known in the art.

Like the MBSs, FBS 65 has a backhaul link that connects it to the remainder of the cellular network. In the example of FIG. 3, this backhaul link includes link 75 between FBS 65 and the internet 81, link 76 through the internet that is typically provided at least in part by an Internet Service Provider (ISP), and a link 77 to the networking equipment 80 of the cellular network. Networking equipment 80 is a control server (also referred to as an Access Service Network Gateway: “ASN-GW” or a Radio Network Controller: “RNC”) for the FBSs of the system. Networking equipment 79 is a control server for the MBSs of the system. The overall backhaul communication link 75-77 from FBS 65 to control server 80 in the illustration is a simplification provided to illustrate that the backhaul link for FBS 65 is provided at least in part by an ISP. The cellular network operator's networking equipment 79 and 80 includes a distributed backhaul controller entity 82 and 83 that manages the backhaul links to the various base stations. The backhaul controller entity 82, 83 can, depending on the circumstance, control the base stations such that more traffic flows through selected base stations and selected backhaul links and such that less traffic flows through other selected base stations and selected backhaul links. The backhaul controller entity 82, 83 can reconfigure base stations and other network equipment, and can instruct selected base stations to shut down and stop operating.

In the example of FIG. 3, a user uses MS1 96 to interact with the cellular network. In conventional cellular network fashion, MS1 96 typically remains in wireless communication with at least one MBS as MS1 96 moves throughout the coverage areas served by the MBSs 51-57. Moreover, if MS1 96 is located in cell 66 then MS1 96 can also communicate with FBS 65. FBS 65 may, for example, be a FBS located in a building and the user may be using MS1 96 within the building.

When located in cell 66, the user of MS1 96 can access the internet via FBS 65, backhaul link 75-77 to networking equipment 80, and from the cellular network back to the internet via link 78. The bandwidth of the short relatively unobstructed RF link between MS1 96 and FBS 65 is greater than the bandwidth of the longer relatively obstructed RF link between MS1 96 and MBS 64. By providing the user with a high bandwidth communication link 75-77 through the cellular network to the internet using such an FBS, the user may tend to use the cellular network to consume bandwidth intensive internet-based services.

FIG. 4 is a more detailed diagram that shows one example of the backhaul link 75 of FIG. 4 between FBS 65 and internet 81. DSL modems and FBSs of multiple users located in many different buildings 84-88 are coupled to the “Local Telecom Operator Office” 89 via ordinary copper telephone lines 90. The information being communicated to and from these many users is aggregated at the “Local Telecom Operator Office” 89 by a “Digital Subscriber Line Access Multiplexer” (DSLAM) onto a single line 91 such as a T1 line. The T1 line 91 is an Asynchronous Transfer Mode (ATM) trunk that extends to an ATM switch 92. The amount of bandwidth available to MS1 96 to the internet therefore depends on the loading by neighborhood devices that are aggregated onto line 91. The next link 93 to ISP2 may, for example, be a link to a router 94 operated by a cable television network operator. The internet traffic that the cellular network operator wants to provide to the user of mobile station 96 is rerouted from the router 94 (operated by the cable television network operator ISP2) to a router 95 (operated by the cellular telephone network operator). Router 95 in this case is part of the cellular network. The link from router 94 to router 95 may be somewhat unreliable. The QoS provided by the backhaul link to FBS 65 is variable due to numerous factors such as the sharing of bandwidth with other aggregated traffic. Service outages of the air-interface of an FBS may result in unpredictable changes in backhaul traffic if the system is operated in a conventional manner. Moreover, backhaul link QoS limitations due to other uses of the backhaul network may limit the level of QoS that a particular user may enjoy using a particular FBS.

In addition to service reliability issues related to the structure and operation of the backhaul link, there are also service reliability issues due to FBS hardware reliability problems. From the perspective of the cellular network, an FBS is generally not as robust as the hardware of an MBS. For example, a user may attempt to move an FBS physically, thereby impacting the effective coverage area of the FBS. The change in coverage area of the FBS may change traffic flows elsewhere in the cellular network. The user may also accidentally power off the FBS and this may result in a disconnection between the FBS and a mobile stations being served by the FBS. The accidental power off may also result in a backhaul link disconnection and surges in backhaul link traffic. When the backhaul links are broken, an existing TCP/IP connection to the mobile station is generally not gracefully transferred, but rather is broken. Packets may be lost. The lost packets must generally be resent across another connection after the other connection to the destination is setup and established.

In addition to the reliability issues mentioned above due to actions by the user of the FBS, there are reliability issues due to structure and operation of the FBS itself. For example, an FBS may interfere with a cellular telephone or other device and as a result the FBS may need to be shut down or idled. Shutting down the FBS may change operation and interference distribution of the cellular network. There may be unacceptable interference if multiple FBSs are densely deployed. To prevent unwanted interference for these reasons and other reasons, the backhaul controller entity 82,83 may instruct a particular FBS to shut down or to go into a low duty mode. As mentioned above, shutting down the FBS may change operation of the cellular network and interference distribution. In addition, relatively unreliable FBSs may cause the MBSs that serve the unreliable FBSs to suffer high levels of unreliability.

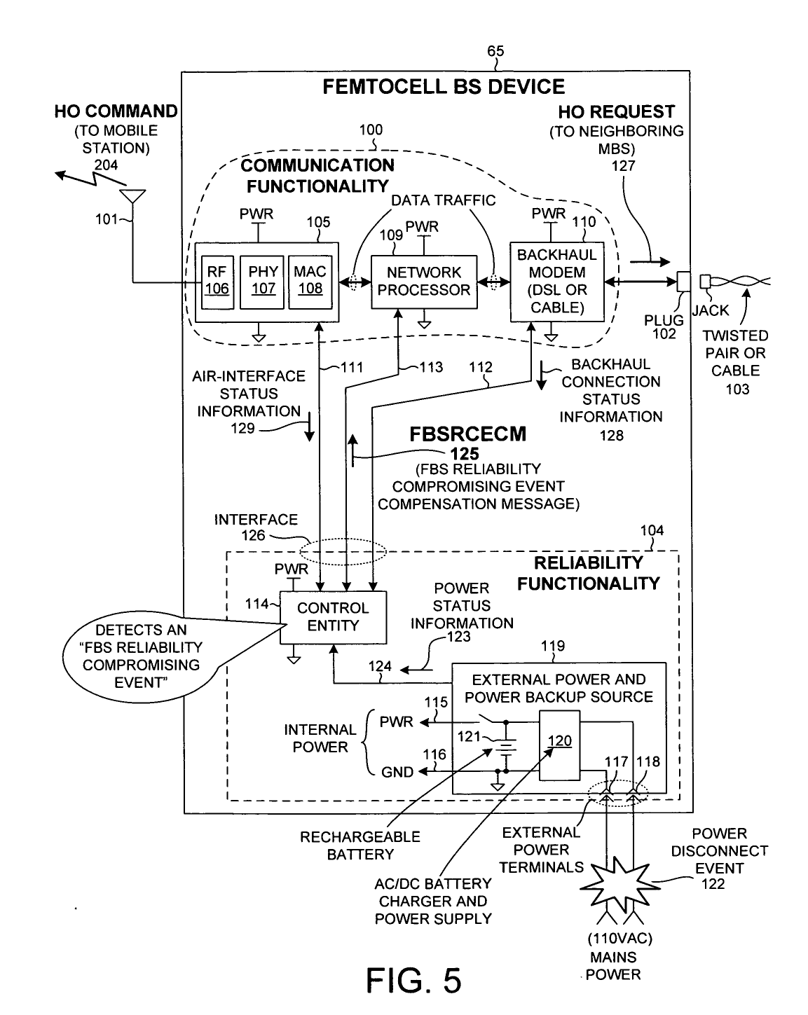

FIG. 5 is a more detailed diagram of FBS 65. FBS 65 has features usable to counter the reliability concerns set forth above. FBS 65 includes a communication functionality 100, an antenna 101, a plug 102 for coupling to a backhaul connection cable 103, and a reliability functionality 104. Cable 103 may be a twisted pair for DSL communication as illustrated, or may be a coaxial cable for coupling with a cable modem, or may be another type of cable used for backhaul communication.

Communication functionality 100 includes an air-interface integrated circuit 105 adapted to send and to receive WiMAX/802.16, UMTS or LTE wireless communications. Air-interface integrated circuit 105 includes an RF transceiver 106, a PHY layer protocol processing functionality 107 and a MAC layer protocol processing functionality 108. Communication functionality 100 further includes a network layer processing functionality 109, and a backhaul modem 110. In the illustrated example, air-interface integrated circuit 105 communicates with the reliability functionality 104 across one or more conductors 111. These conductors 111 are typically conductors on a printed circuit board upon which integrated circuit 105 is disposed. Similarly, in the illustrated example, backhaul modem 110 communicates with the reliability functionality 104 across one or more conductors 112. Communication between network processor 109 and the reliability functionality 104 may pass across similar conductors 113 on the printed circuit board as illustrated in FIG. 5 in situations in which network processor 109 and control entity 114 are disposed on different integrated circuits. Alternatively, the network processor 109 and a control entity 114 of the reliability functionality 104 are realized using hardware and/or software disposed on the same integrated circuit. Communication between the network processor 109 and the control entity 114 in such cases may occur using registers or memory locations or other mechanisms usable to pass information from one subroutine or dedicated hardware circuit to another subroutine or dedicated hardware circuit within a larger overall processor circuit. Communication between the various parts of the communication functionality 100 and the reliability functionality 104 can occur across multiple separate dedicated conductors as illustrated, or in other examples can occur across a single bus. In the event a single bus is used, interface 126 may be a bus interface for a standard serial bus commonly used to communicate between integrated circuits. Of importance, the communication functionality 100 is powered by internal power (internal to FBS 65) received from the reliability functionality 104 across power PWR and ground GNS conductors 115 and 116.

Reliability functionality 104 includes external power terminals 116 and 117 for receiving 110 volt AC power from an external source such as a wall plug, an External Power And Power Backup Source (EPPBS) 119, and the control entity 114. EPPBS 119 includes an AC-to-DC power supply and battery charging circuit 120 and a rechargeable battery 121. The AC-to-DC power supply and battery charging circuit 120 receives 110 or 220 Volt AC power from terminals 117 and 118, generates therefrom a regulated DC voltage on conductors 115 and 116, and maintains rechargeable battery 121 in a charged state. As long as FBS 65 is connected to a suitable external power source, EPPBS 119 performs its AC-to-DC power supply function and supplies a DC supply voltage to communications functionality 100 via PWR and GND conductors 115 and 116. If, however, FBS 65 were to become unplugged from the external power source as represented by the power disconnect event star symbol 122, then EPPBS 119 continues to supply the DC supply voltage to communications circuitry 100 via PWR and GND conductors 115 and 116 but the energy for this supply originates from battery 121. In response to the power disconnect event 122, EPPBS 119 also outputs power status information 123. In the present example, power status information 123 is a multi-bit digital value communicated across conductors 124. Power status information 123 alerts control entity 114 of the power disconnect event. In response to receiving power status information 123 from EPPBS 119, control entity 114 sends an “FBS Reliability Compromising Event Compensation Message” (FBSRCECM) 125 to communication functionality 100. As explained in further detail below, FBSRCECM 125 may cause communication functionality 100 to initiate a handover of a connection between FBS 65 and MS1 96 to MBS 64 such that the connection then exists between MS1 96 and MBS 64. The connection is gracefully transferred from the FBS to the MBS.

In one example, reliability functionality 104 is a separately encased module that is manufactured separately from the remainder of FBS 65. The module has a hardware interface 126 involving a plurality of terminals. The FBSRCECM 125 is output by control entity 114 such that the FBSRCECM 125 passes out of the module through the terminals of the interface 116. The module may removably plug into the remainder of FBS 65 such that control entity 114 can communicate across interface 126 with communication functionality 100. In this example, control entity 114 is realized on one integrated circuit of the module, whereas the communication functionality 100 is realized on multiple other integrated circuits outside of the module.

In another example, reliability functionality 104 is not a separately encased module, but rather control entity 114 is a set of processor-executable instructions executing on a suitable processor. This processor also executes other sets of processor-executable instructions in carrying out an operation of the communication functionality 100. The processor may, for example, be a Digital Signal Processor (DSP) integrated circuit that executes a control entity sub-routine of processor-executable instructions and that also executes a network processor sub-routine of processor-executable instructions.

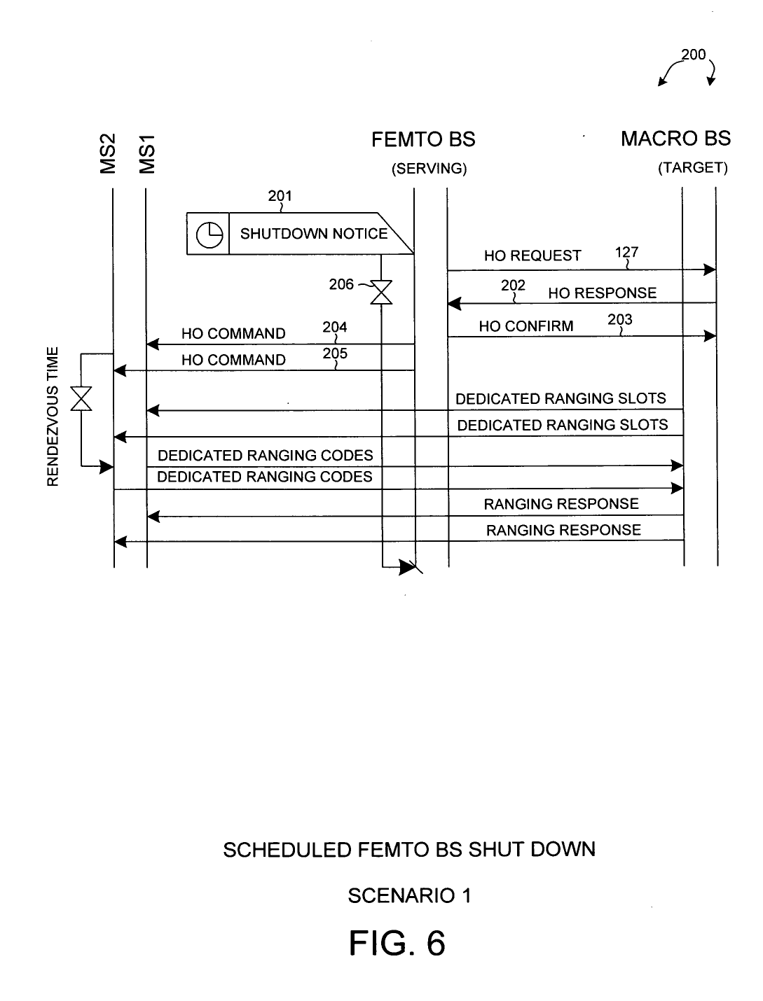

FIG. 6 is a flowchart of a first method 200 involving a scheduled FBS shut down. In FIG. 6, the label MS1 denotes MS1 96 of FIG. 3. Label MS2 denotes another mobile station (not shown) within cell 66 served by FBS 65. The “FEMTO BS” notation denotes FBS 65 of FIG. 3. The “MACRO BS” notation denotes MBS 64 of FIG. 3. In the diagram of FIG. 6, time extends downward. In method 200, a shut down notice 201 occurs and in response FBS 65 sends a handover request message 127 to MBS 64. Shut down notice 201 may, for example, be a notice received from the backhaul controller entity 82, 83 via the backhaul network. The notice may be an instruction to FBS 65 to shut down due to interference problems. The shut down notice is passed to the control entity 114 in the form of backhaul connection status information 128 (see FIG. 5). Control entity 114 receives information 128 and in response sends an appropriate FBSRCECM 125 to communication functionality 100. FBSRCECM 125 instructs communication functionality 100 to generate and send the handover request 127 to MBS 64.

Next, as illustrated in FIG. 6, MBS 64 responds by sending a handover response 202 back to FBS 65 via the backhaul network. Handover response 202 is received by backhaul modem 109 of FBS 65. In response, FBS 65 sends a confirmation 203 back to MBS 64 via the backhaul network. This handover request, response, and confirm mechanism may be a conventional mechanism employed in the cellular network.

Next, FBS 65 sends a handover command message to each of the mobile stations FBS 65 is serving. In the example of FIG. 6, handover command 204 goes to MS1 96 denoted MS1 and handover command 205 goes to another MS denoted MS2 (not illustrated). The mobile stations MS1 and MS2 and the base stations FBS 65 and MBS 64 then communicate with one other in order to carry out and complete the handover process in standard fashion. During the entire time this handover process is occurring, the FBS 65 is certain to be powered due to energy stored in battery 121. Typically the circuitry of the FBS 65 is powered at least to some extent during this time by energy previously stored in battery 121. After the handover process is complete, for example as determined by expiration of a timer in FBS 65 as indicated by symbol 206, the FBS 65 stops operating and shuts down. In one example, this shutting down involves the reliability functionality 104 no longer providing internal power via conductors 115 and 116 to communication functionality 100 and control entity 114. Accordingly, rather than FBS 65 causing reliability issues in the cellular network due to broken connections between the FBS and mobile stations and/or due to broken connections between the FBS and the backhaul network when FBS 65 shuts down, the FBS 65 remains operational and initiates an orderly handover and then after the handover has been completed shuts down gracefully thereby reducing adverse impact on the cellular network.

In one example, when the high bandwidth link between a mobile station and FBS 65 is lost and the traffic is to be transferred to a lower bandwidth link between the mobile station and a macro base station, QoS for the mobile stations may be maintained by handing over some of the mobile stations to one macro base station and handing over other of the mobile stations to another macro base station. How the handover is to be performed as indicated by the backhaul controller entity 82, 83 in the handover response 202, and this information is passed on as appropriate by FBS 65 to mobile stations MS1 and MS2 as part of the handover commands 204 and 205. In response, each mobile station attempts to handover to a different specified macro base station if multiple macro base stations are within range.

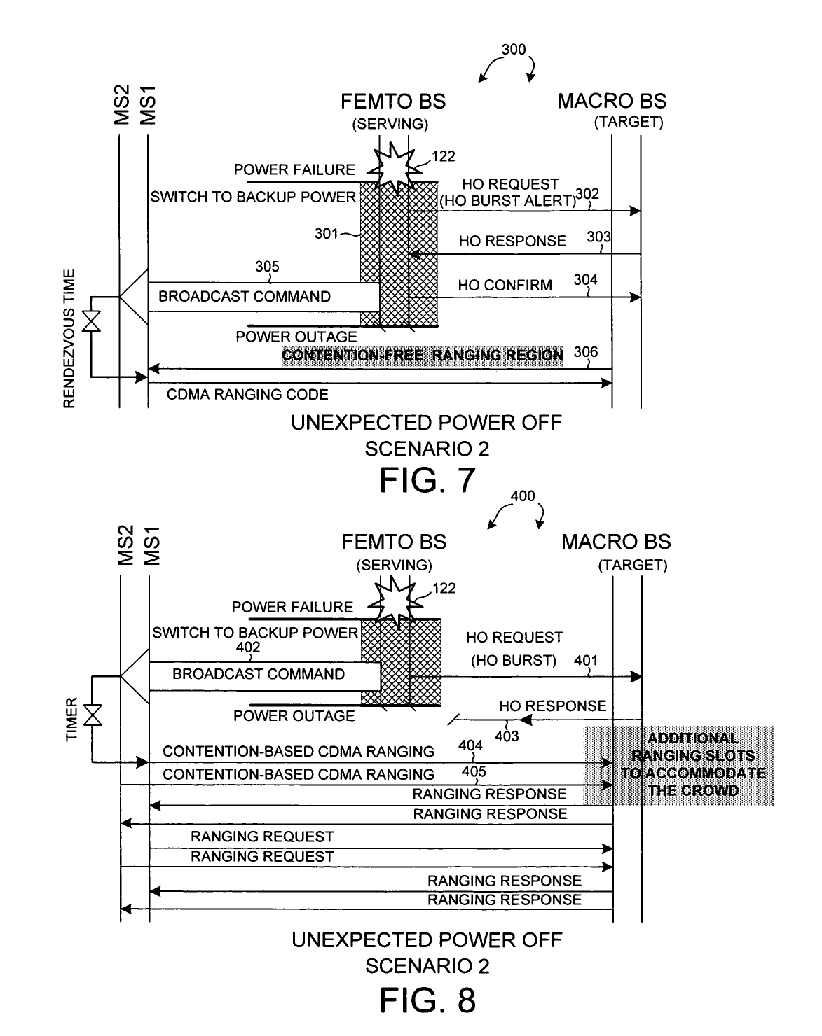

FIG. 7 is a flowchart of a second method 300 involving an unexpected power off of FBS 65. In response to a power failure or unexpected power disconnect event 122, EPPBS 119 (see FIG. 5) sends power status information 123 to control entity 114 informing control entity 114 of the power failure. EPPBS 119 supplies the communication functionality 100 and control entity 114 with backup power from battery 121 via conductors 115 and 116. The supplying of power by EPPBS 119 in FIG. 7 is illustrated by the cross-hatched shaded area 301.

Control entity 114 receives the power status information 123 and in response sends an appropriate FBSRCECM 125 to the communication functionality 100. FBSRCECM 125 instructs the communication functionality 100 to initiate a handover. Communication functionality 200 responds by sending a handover request message 302 via the backhaul network. The handover request message 302 initiates a handover operation involving message 302, a handover response message 303, and a handover confirm message 304 as illustrated in FIG. 7. This handover process is not a conventional one, but rather FBS 65 informs MBS 64 of the number of handover users to expect as a result of event 122. MBS 64 uses this burst alert to make preparations to prevent a potential ranging flash crowd. In one example, MBS 64 provides a contention-free ranging region by designating particular ranging slots for the flash crowd and by reserving other ranging slots for other traffic. Communication of the contention-free ranging region is illustrated in FIG. 7 by arrow 306. In another example, MBS 64 allocates additional ranging slots in response to the handover request directed from the FBS and to accommodate the many handover users. This “additional ranging slots” example is illustrated below in FIG. 8.

In response to unexpected power disconnect event 122, communication functionality 100 also broadcasts a broadcast and handover command 305 from its air-interface to the mobile stations MS1 and MS2 that FBS 65 is serving. In the example of FIG. 7, the FBS 65 is powered down before the handover is completed, but the handover process is nonetheless conducted gracefully in the fashion as illustrated. FBS 65 handshakes with its neighboring MBS 64 to initiate the handover and also commands the mobile stations MS1 and MS2 in a handover command to handover before EPPBS 119 stops powering the FBS. The mobile stations, having received broadcast handover comment 305, complete the handover from FBS 65 to MBS 64 using the quarantine ranging region even though FBS 64 has stopped operating.

FIG. 8 is a flowchart of a third method 400 involving an unexpected power off of FBS 65. In the example of FIG. 8, the unexpected power disconnect event 122 occurs, but the FBS 65 stops operating even before handover handshaking with MBS 64 can be completed. EPPBS 119 (see FIG. 5) detects power disconnect event 122, and in response sends power status information 123 to control entity 114. As in the example of FIG. 7, the power status information 123 informs control entity 114 of the power failure. Control entity 114 in turn sends FBSRCECM 125 to the communication functionality 100, thereby causing a handover request message 401 and a broadcast and handover command to be sent out of FBS 65. FBS 65 stops operating before standard handshaking with MBS 64 can be completed. MBS 64 sends a handover response 403, but it is not received by FBS 65 nor is it acknowledged. The mobile stations and the macro base station are configured to complete the handover by themselves without the FBS as illustrated. The mobile stations MS1 and MS2 send communications 404 and 405 to MBS 64 and interact MBS 64 to complete the handover. In some examples, this may be triggered by timers in MS1 and MS2. Such a timer starts from the broadcast command from the FBS, where the timer may be preconfigured or may be configured according to the value indicated in the broadcast command from the FBS. MBS 64 provides for the handover crowd by providing additional ranging slots. In some examples, both techniques of providing additional ranging slots for the handover crowd and of providing quarantine ranging regions for the handover crowd are used together.

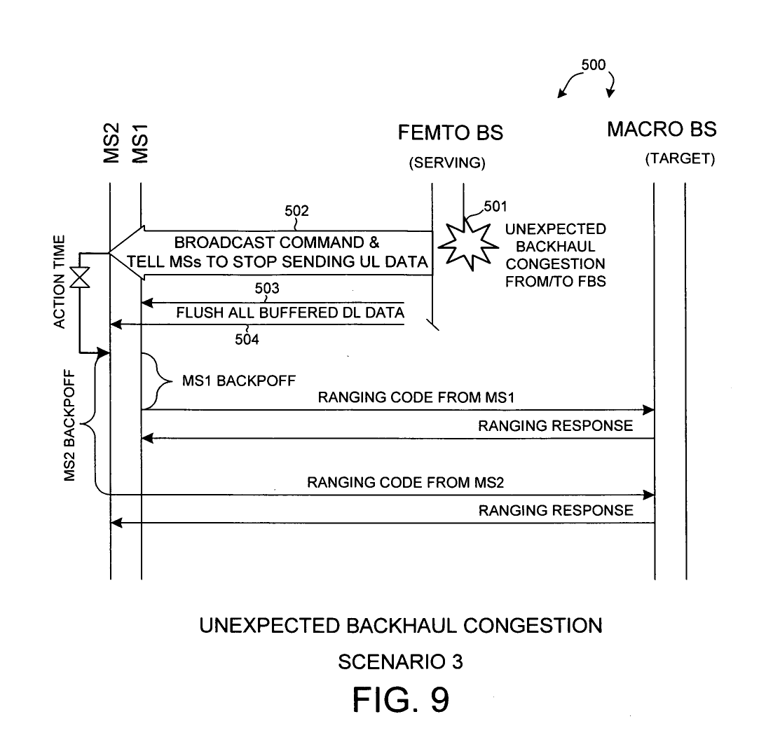

FIG. 9 is a flowchart of a fourth method 500 involving unexpected backhaul congestion from and/or to FBS 65. Unexpected backhaul congestion occurs as indicted by the star symbol 501. FBS 65 may determine that its backhaul link is not working properly by itself without being informed, or alternatively FBS 65 may receive a message from the backhaul network itself informing the FBS 65 of the backhaul congestion problem. The backhaul link between FBS 65 and MBS 64 may be totally unusable, or may suffer and undesirably large amount of congestion.

In one example, the backhaul controller entity 82, 83 (see FIG. 3) informs FBS 65 of backhaul congestion by sending FBS 65 a message via the backhaul network. The message is received by backhaul modem 110 (see FIG. 5), and the information is forwarded to control entity 114 in the form of backhaul connection status information 128 (see FIG. 5). Control entity 114 responds by sending a FBSRCECM 125 back to communication functionality 100. The FBSRCECM 125 causes a broadcast and handover command 502 to be sent from the air-interface to all mobile stations MS1 and MS2. Any data destined for mobile stations that had been buffered in FBS 65 is also forwarded to the appropriate mobile stations MS1 and MS2 as indicated by arrows 503 and 504. The mobile stations MS1 and MS2 seek to establish communication with MBS 64 as illustrated without using the backhaul link between FBS 64 and the backhaul network. In the case of MS1 96 being used to receive streaming video from the backhaul network via FBS 65, the handover from FBS 65 to MBS 64 is completed before the buffered video data 503 has been consumed and viewed, and as a result service disruption in the viewing of the video on MS1 96 is avoided.

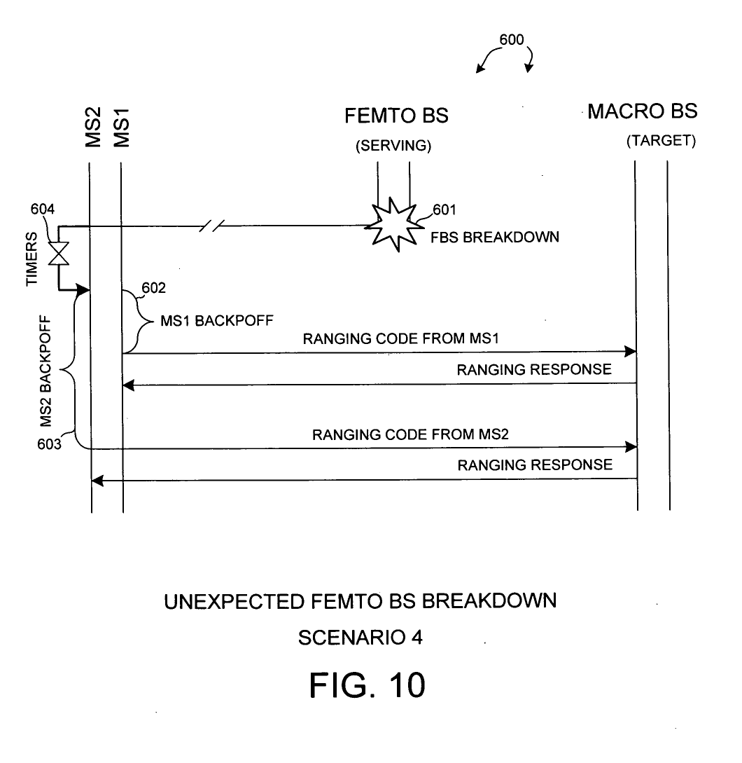

FIG. 10 is a flowchart of a fifth method 600 involving an unexpected breakdown of the FBS 65. In this scenario, FBS 65 breaks down without informing either the MBS 64 or the mobile stations MS1 and MS2 that it will no longer be operating. In this scenario, unfortunately, the reliability functionality 104 of FBS 65 does not provide for enhanced cellular network reliability. The MBSs that fail to receive communications from FBS 65, however, are configured to attempt to establish communication with MBS 64 using a timer and backoff mechanism that prevents ranging flash crowding and prevents loss of TCP/IP connections. In the example of FIG. 10, mobile stations MS1 and MS2 have timers 604 to detect breakdown of the FBS. After timers 604 expire and FBS 65 detects breakdown 601, and before any connections extending to the mobile stations MS1 and MS2 are broken or are declared “out of service”, MS1 uses backoff period 602 to send a ranging code to MBS 64 whereas MS2 uses backoff period 603 to send a ranging code of MBS 64. Reception of the ranging codes by MBS 64 is spread out over time. Throughout the handover process of FIG. 10, mobile stations MS1 and MS2 remain authenticated and registered with the network, so the mobile stations MS1 and MS2 perform the handover operations to MBS 64 without loss of their respective connections.

Although not pictured in a diagram, control entity 114 of FIG. 5 can also be prompted to send FBSRCECM 125 as a result of air-interface status information 129 received from communication functionality 100. An example of air-interface status information 129 is a message indicating a level of air-interface congestion. In response to receiving this information 129, control entity 114 sends an appropriate FBSRCECM 125 thereby initiating a handover of a link to a mobile station served by FBS 65 to MBS 64. The method of messaging appears much as method 600 of FIG. 10 in that FBS 65 does not communicate with the mobile stations to be handed over. Unlike the method 600 of FIG. 10, however, FBS 65 may inform MBS 64 via the backhaul network that it will be receiving handover users. MBS 64 may therefore employ the contention-free ranging region technique of FIG. 7 and/or the additional ranging slots technique of FIG. 8 to prevent a handover crowd problem. Although examples are set forth above where FRCECM 125 results in a handover, in other examples the communication function is made to send other messages. For example, a message may be sent from FBS 65 to the backhaul controller entity 82, 83 to increase FBS backhaul connection throughput. A message may be sent from FBS 65 to the backhaul controller entity 82, 83 that both indicates an error condition and also includes a recommendation for fixing the error condition.

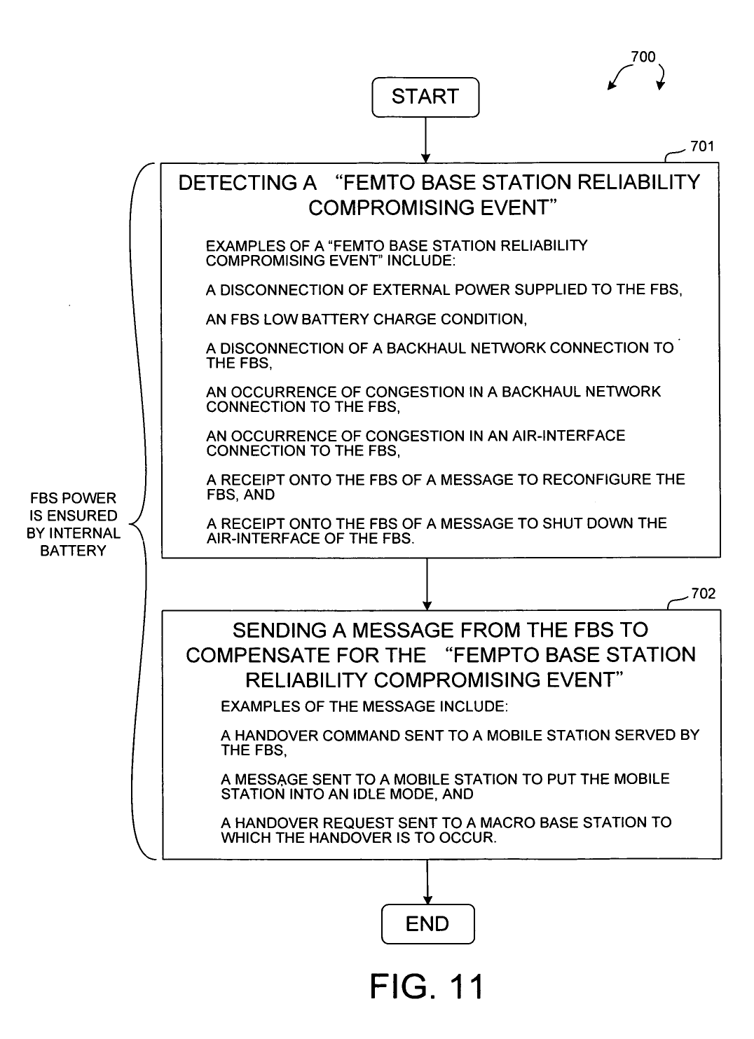

FIG. 11 is a flowchart of a generalized novel method 700 involving FBS 65 of FIG. 5. In a first step (step 701), an “FBS Reliability Compromising Event” is detected on the FBS. Examples of an FBS Reliability Compromising Event include, but are not limited to: 1) a disconnection of external power supplied to the FBS, 2) an FBS low battery charge condition, 3) a disconnection of a backhaul network connection to the FBS, 4) an occurrence of congestion in a backhaul network connection to the FBS, 5) an occurrence of congestion in an air-interface connection to the FBS, 6) a receipt onto the FBS of a message to reconfigure the FBS, and 7) a receipt onto the FBS of a message to shut down the air-interface of the FBS. In a second step (step 702), FBS 65 sends a message from the FBS to compensate for the “FBS Reliability Compromising Event” detected in step 701. Examples of the message include, but are not limited to: 1) a command sent to a mobile station served by the FBS for triggering handover, 2) a message sent to a mobile station to put the mobile station into an idle mode, 3) a handover request sent to a macro base station to which the handover is to occur, and 4) a command sent to the backhaul modem to request reconfiguration of the backhaul connection bandwidth or QoS level.

In one example of the generalized method 700, the “FBS Reliability Compromising Event” is an unscheduled disconnection of external power supplied to FBS 65. The control entity 114 detects this event as a result of receiving power status information 123 from EPPBS 119. The power status information 123 indicates that external power has been lost and/or indicates the amount of charge on battery 121. As a result of receiving information 123, control entity detects the “FBS Reliability Compromising Event.” Control entity 114 then sends FRCECM 125 to communication functionality 100, thereby initiating a handover as illustrated in either FIG. 7 or FIG. 8. Power to FBS 65 is ensured during steps 701 and 702 due to EPPBS 119 and battery 121.

Although the present invention is described above in connection with certain specific embodiments for instructional purposes, the present invention is not limited thereto. The generalized method of FIG. 11 is applicable to femto base stations utilizing various different air-interface communication protocols other than WiMAX including LTE, GSM, UMTS, CDMA200, and TD-SCDMA. Accordingly, various modifications, adaptations, and combinations of various features of the described embodiments can be practiced without departing from the scope of the invention as set forth in the claims.

What is claimed is:

1. A reliability functionality comprising:
a control entity that receives status information and in response outputs a Femto Base Station Reliability Compromising Event Compensation Message (FBSRCECM).

2. The reliability functionality of claim 1, wherein the FBSRCECM includes a plurality of digital bits, wherein the control entity involves a first set of processor-executable instructions executing on an integrated circuit within a femto base station, and wherein the outputting of the FBSRCECM from the control entity involves communicating the FBSRCECM from the control entity to a second set of processor-executable instructions executing on the integrated circuit.

3. The reliability functionality of claim 1, wherein the FBSRCECM includes a plurality of digital bits, wherein the control entity is a portion of a first integrated circuit within a femto base station, and wherein the outputting of the FBSRCECM from the control entity involves outputting the FBSRCECM from the first integrated circuit to a second integrated circuit within the femto base station.

4. The reliability functionality of claim 1, further comprising:
an External Power and Power Backup Source (EPPBS) comprising external power terminals and a battery, wherein the EPPBS generates the power status information and supplies the power status information to the control entity.

5. The reliability functionality of claim 4, wherein the reliability functionality is a module that includes the control entity and the EPPBS, wherein the module has an interface comprising a plurality of terminals, and wherein the control entity outputs the FBSRCECM onto the interface.

6. The reliability functionality of claim 4, wherein the control entity receives backhaul connection status information from a backhaul modem.

7. The reliability functionality of claim 4, wherein the control entity receives air-interface status information from an air-interface.

8. A battery-backed up Femto Base Station (FBS) comprising:
external power terminals;
a rechargeable battery; and
a communication functionality including an air-interface and a backhaul modem, wherein the communication functionality transmits a message out of the FBS in response to a power disconnect event, wherein the power disconnect event is an event in which energy is no longer being received onto the FBS via the external power terminals.

9. The battery-backed up FBS of claim 8, wherein the communication functionality communicates in accordance with an IEEE 802.16 communication standard, and wherein the rechargeable battery powers the communication functionality during transmission of at least a part of the message.

10. The battery-backed up FBS of claim 9, wherein the message transmitted out of the FBS is a handover request message transmitted from the backhaul modem.

11. The battery-backed up FBS of claim 9, wherein the message transmitted out of the FBS is a handover command message transmitted from the air-interface.

12. A method comprising:
(a) detecting a femto base station reliability compromising event in a Femto Base Station (FBS); and
(b) in response to said detecting sending a message to a mobile station served by the FBS, wherein the message is taken from the group consisting of: a handover command, and a command to enter an idle mode, and wherein (a) and (b) are performed by the FBS.

13. The method of claim 12, wherein the FBS communicates in accordance with a IEEE 802.16 communication protocol, and wherein the FBS reliability compromising event is taken from the group consisting of: a disconnection of external power supplied to the FBS, a low battery charge condition, a disconnection of a backhaul network connection to the FBS, an occurrence of congestion in a backhaul network connection to the FBS, an occurrence of congestion in an air-interface connection to the FBS, a receipt onto the FBS of a message to reconfigure the FBS from a backhaul controller, and a receipt onto the FBS of a message to shut down the FBS from a backhaul controller.

14. The method of claim 12, wherein said detecting of (a) involves receiving backhaul network condition information onto a backhaul modem of the FBS from a backhaul network.

15. The method of claim 14, further comprising:
(c) in response to said detecting of (a) sending a message out of the FBS to a backhaul controller, wherein the message of (c) results in higher FBS backhaul connection throughput.

16. The method of claim 14, further comprising:
(c) in response to said detecting of (a) sending a message out from the FBS, wherein the message of (c) includes information indicative of the FBS reliability compromising event.

17. The method of claim 16, wherein the FBS includes a network processor, and wherein (c) involves instructing the network processor to initiate forming and sending of the message of (c).

18. The method of claim 16, wherein the FBS reliability compromising event of (a) is an error condition, and wherein the message of (c) includes a recommendation for fixing the error.

19. A Femto Base Station (FBS) comprising:
a communication functionality including an air-interface and a backhaul modem, wherein the FBS communicates in accordance with a IEEE 802.16 communication protocol; and
a control entity that causes the communication functionality to send a message in response to an FBS reliability compromising event, wherein the FBS reliability compromising event is taken from the group consisting of: a disconnection of external power supplied to the FBS, a low battery charge condition, a disconnection of a backhaul network connection to the FBS, an occurrence of congestion in a backhaul network connection to the FBS, an occurrence of congestion in an air-interface connection to the FBS, a receipt onto the FBS of a message to reconfigure the FBS from a backhaul controller, and a receipt onto the FBS of a message to shut down the FBS from a backhaul controller, and wherein the message sent from the communication functionality is taken from the group consisting of: a handover command, a command to enter a low duty mode, and a handover request.

20. The FBS of claim 19, further comprising:
an External Power and Power Backup Source (EPPBS) that sends power status information to the control entity, and wherein the power status information is indicative of the FBS reliability compromising event.

21. The FBS of claim 19, wherein the control entity receives an indication of the FBS reliability compromising event from the communication functionality.

22. The FBS of claim 19, wherein the control entity is a part of a first integrated circuit, wherein the communication functionality involves a second integrated circuit, and wherein the control entity causes the communication functionality to send the message by communicating an FBS Reliability Compromising Event Compensation Message (FBSRCECM) from the first integrated circuit to the second integrated circuit.

23. The FBS of claim 19, wherein the control entity involves a first set of processor-executable instructions executing on an integrated circuit within the femto base station, wherein the communication functionality involves a second set of processor-executable instructions executing on the integrated circuit, and wherein the control entity causes the communication functionality to send the message by communicating an FBS Reliability Compromising Event Compensation Message (FBSRCECM) from the first set of processor-executable instructions to the second set of processor-executable instructions.

24. A Femto Base Station (FBS) comprising:
a communication functionality including an air-interface processor, a network processor and a backhaul modem, wherein the communication functionality transmits a message out of the FBS in response to receiving a Femto Base Station Reliability Compromising Event Compensation Message (FBSRCECM) from another portion of the FBS.

25. The FBS of claim 24, further comprising:
an External Power and Power Backup Source (EPPBS) comprising external power terminals and a rechargeable battery, wherein the EPPBS supplies the FBSRCECM to the communication functionality, and wherein the rechargeable battery powers the communication functionality during transmission of at least a part of the message transmitted out of the FBS.

26. The FBS of claim 24, further comprising:
an External Power and Power Backup Source (EPPBS) comprising external power terminals and a rechargeable battery, wherein the FBSRCECM is a message that indicates a power disconnect event reported by the EPPBS.

27. The FBS of claim 24, wherein the message transmitted out of the FBS is a message that indicates a scheduled power down command instructed from a backhaul controller.

28. The FBS of claim 24, wherein the message transmitted out of the FBS is a message indicating congestion of a backhaul connection reported by a backhaul modem.

29. The FBS of claim 24, wherein the message transmitted out of the FBS is a message indicating an amount of backhaul connection throughput, wherein the amount of backhaul connection throughput is reported by backhaul modem.

30. The FBS of claim 24, wherein the message transmitted out of the FBS is a message indicating an aggregated throughput requirement due to traffic between the FBS and a plurality of mobile stations, wherein the aggregated throughput requirement is estimated by an air-interface processor of the FBS.

31. The FBS of claim 24, wherein the message transmitted out of the FBS is a handover request transmitted from the network processor through the backhaul modem.

32. The FBS of claim 24, wherein the message transmitted out of the FBS is a broadcast command transmitted from the air-interface processor to inform a mobile station of a power down status of the FBS and to cause the mobile station to handover.

33. The FBS of claim 24, wherein the message transmitted out of the FBS is a handover request to request a mobile station handover.

34. The FBS of claim 24, wherein the message transmitted out of the FBS is transmitted from the air-interface processor to request that a mobile station handover to another base station if an achievable throughput is less than an aggregated throughput.

35. The FBS of claim 24, wherein the message transmitted out of the FBS is transmitted from the backhaul modem to adjust an achievable throughput if the achievable throughput has a predetermined relationship with respect to an aggregated throughput.

36. The FBS of claim 24, wherein the message transmitted out of the FBS is transmitted from the air-interface processor to request a mobile station enter an idle mode.

37. The FBS of claim 24, wherein the message transmitted out of the FBS is transmitted from the air-interface processor to request that a mobile station update a paging identifier to be the same as a paging identifier used by another base station.
